(19) United States
(12) Patent Application Publication
(10) Pub. No.: US 2021/0237193 A1
(43) Pub. Date: Aug. 5, 2021

(54) RESISTANCE SPOT WELDING JOINT FOR ALUMINUM MEMBERS, AND RESISTANCE SPOT WELDING METHOD FOR ALUMINUM MEMBERS

(71) Applicants: KABUSHIKI KAISHA KOBE SEIKO SHO (KOBE STEEL, LTD.), Kobe-shi (JP); NADEX CO., LTD., Nagoya-shi (JP)

(72) Inventors: Takuro AOKI, Kanagawa (JP); Seiji KATAYAMA, Aichi (JP); Yoshinori OTA, Aichi (JP); Kenji SAHASHI, Gifu (JP)

(73) Assignees: KABUSHIKI KAISHA KOBE SEIKO SHO (KOBE STEEL, LTD.), Kobe-shi (JP); NADEX CO., LTD., Nagoya-shi (JP)

(21) Appl. No.: 17/048,845

(22) PCT Filed: Apr. 19, 2019
(86) PCT No.: PCT/JP2019/016905

§ 371 Date: Oct. 19, 2020

(30) Foreign Application Priority Data
Apr. 20, 2018 (JP) 2018-081781

(51) Int. Cl. B23K 11/11; B23K 11/24

(52) U.S. Cl. CPC B23K 11/115; B23K 2103/10; B23K 11/241

(57) ABSTRACT

A resistance spot welded joint of an aluminum material is obtained by joining a stack of a plurality of aluminum materials by spot welding. A nugget formed by the spot welding includes a solidified part of the aluminum materials and a shell having a different solidification structure from the solidified part. The shell is formed annularly in a cross-section of the nugget in a stacking direction of the aluminum materials. The solidified part and the shell are alternately arranged from an outer edge of the nugget toward a nugget central part.

### TECHNICAL FIELD

The present invention relates to a resistance spot welded joint of an aluminum material, and a resistance spot welding method of an aluminum material.

### BACKGROUND ART

An aluminum material has a low electric resistance and high thermal conductivity, compared with a steel material, and therefore in performing resistance spot welding, the welding current must be about 3 times higher than the case of a steel material, and the pressure force of an electrode for spot welding must be about 1.5 times higher than the case of a steel material. Accordingly, it is very difficult to adopt and apply welding conditions of resistance spot welding of a steel material to the resistance spot welding of an aluminum material, and welding conditions optimal for an aluminum material need to be newly found out.

As an example of the resistance spot welding method of an aluminum material, for example, Patent Literature 1 discloses a technique in which the pressure force of an electrode is changed in two steps and the current value is changed in two steps (from large current to small current) depending on the pressure force.

In addition, Patent Literature 2 discloses a technique in which a cool down time is provided after a main current supply for welding and a temper current supply, in which the current is weaker than the current of the main current supply supplied, is performed after the cool down time.

### CITATION LIST

### Patent Literature

Patent Literature 1: Japanese Patent No. 3862640

Patent Literature 2: JP-A-H5-383

### SUMMARY OF INVENTION

### Technical Problem

Meanwhile, in the case of resistance spot welding of thick aluminum alloy plates, a blowhole is sometimes formed within molten aluminum to form a nugget, due to deposits on the plate surface, such as oxide film, rust, moisture and organic material, or due to evaporation of a low vapor-pressure component in a material.

Typically, in the case where a blowhole is present in the aluminum material joint, the elongation of the joint part is reduced, and ductility of the joint is lost, such that brittle fracture is likely to occur. Particularly, in the case of using an aluminum material as a structural member requiring high strength, the presence of a blowhole greatly affects the reliability as a structural member.

In the techniques described in the literatures in Citation List above, various resistance spot welding methods for an aluminum plate have been proposed, but the phenomenon until nugget formation is not exactly elucidated in many aspects, and the blowhole cannot yet be controlled to a practically sufficient level.

An object of the present invention is to provide a resistance spot welded joint of an aluminum material and a resistance spot welding method of an aluminum material, in which in resistance spot welding of an aluminum material, generation of a blowhole and a distribution thereof in the nugget are controlled to enhance the quality of the welded part (the welded part properties such as mechanical property in the welded part: hereinafter, referred to as welded part quality).

### Solution to Problem

The present embodiments provide the following configurations.

(1) A resistance spot welded joint of an aluminum material, obtained by joining a stack of a plurality of aluminum materials by spot welding, in which:

a nugget formed by the spot welding includes a solidified part of the aluminum materials and a shell having a different solidification structure from the solidified part;

the shell is formed annularly in a cross-section of the nugget in a stacking direction of the aluminum materials; and

the solidified part and the shell are alternately arranged from an outer edge of the nugget toward a nugget central part.

(2) A resistance spot welding method of an aluminum material, including conducting, in the following order:

a first step of stacking a plurality of aluminum materials and sandwiching the stack between electrodes for spot welding;

a second step of performing a main current supply for forming a nugget between the aluminum materials sandwiched between the electrodes; and

a third step of performing, before the nugget is completely solidified, a pulsation current supply in which supplying a current between the electrodes and stopping supplying the current between the electrodes are repeated a plurality of times, thereby forming a solidified part of the aluminum materials and a shell having a different solidification structure from the solidified part inside the nugget, the solidified part and the shell being alternately formed from an outer edge of the nugget toward a nugget central part in a cross-section in a stacking direction of the aluminum materials.

### Advantageous Effects of Invention

In the present invention, in resistance spot welding of aluminum materials, generation of a blowhole or distribution of the blowhole in a nugget is controlled, such that the welded part quality can be enhanced.

### BRIEF DESCRIPTION OF DRAWINGS

FIG. 1 is a schematic configuration view of a spot welder for welding aluminum materials.

FIG. 2 is a timing chart illustrating an example of the waveform of the welding current.

FIG. 3A and FIG. 3B are process explanatory views for schematically illustrating the state of a nugget from the first-stage main current supply to the second-stage pulsation current supply.

FIG. 4A to FIG. 4D are explanatory views for schematically illustrating the state in the course of forming a nugget.

FIG. 5 is a timing chart illustrating an example of the waveform of the welding current in the case of resistance spot welding including a preliminary current supply step, a cooling step, a main current supply step, and a pulsation current supply step.

FIG. 6A to FIG. 6C are process explanatory views for schematically illustrating the state from the preliminary current supply step to the cooling step.

FIG. 7A and FIG. 7B are process explanatory views for schematically illustrating how the main current supply step is performed after the cooling step.

FIG. 8A and FIG. 8B are explanatory diagrams illustrating respectively a timing chart of current supply of Test Example A1 and a cross-sectional photograph of the nugget of Test Example A1.

FIG. 9A is a timing chart of current supply in Test Example B1, FIG. 9B is a cross-sectional photograph of the nugget of Test Example B1, and FIG. 9C is a partially enlarged photograph of FIG. 9B.

FIG. 10A is a timing chart of current supply in Test Example D2, FIG. 10B is a cross-sectional photograph of the nugget of Test Example D2, and FIG. 10C is a partially enlarged photograph of FIG. 10B.

### DESCRIPTION OF EMBODIMENTS

The embodiments of the present invention are described in detail below by referring to the drawings.

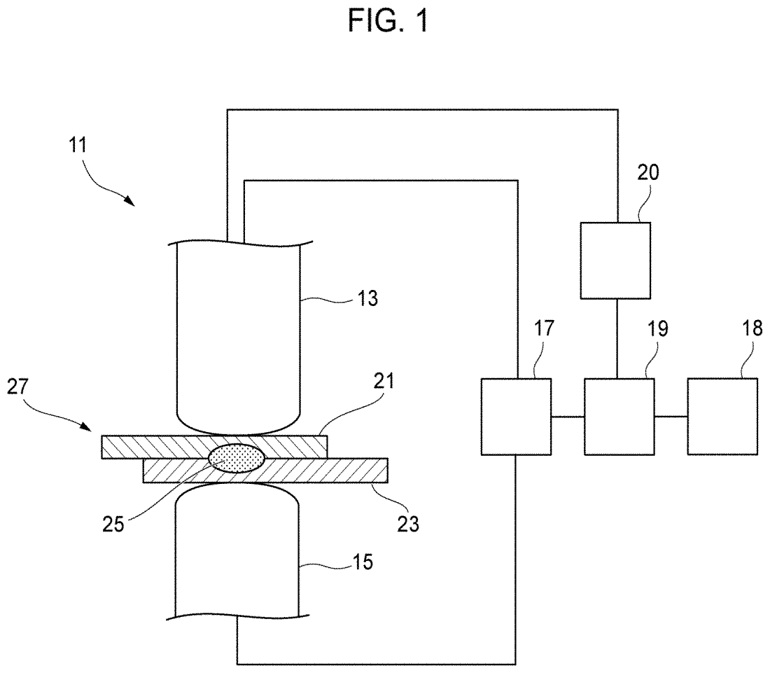

FIG. 1 is a schematic configuration view of a spot welder for welding aluminum materials.

A spot welder 11 includes a pair of electrodes 13 and 15, a welding transformer unit 17 connected to the pair of electrodes 13 and 15, a power supply unit 18, a control unit 19 for supplying a welding power to the welding transformer unit 17 from the power supply unit 18, and an electrode driving unit 20 for moving the pair of electrodes 13 and 15 in the axial direction. The control unit 19 comprehensively controls the current value, current supplying time, pressure force of an electrode, current supply timing, timing of pressurization, etc.

In the spot welder 11, at least two sheets of an aluminum material, i.e., a first aluminum sheet 21 and a second aluminum sheet 23, are stacked and sandwiched between the pair of electrodes 13 and 15. The electrodes 13 and 15 are then driven by the electrode driving unit 20 to pressurize the first aluminum sheet 21 and the second aluminum sheet 23 in the sheet thickness direction. In this pressurized state, the welding transformer unit 17 supplies a current between electrodes 13 and 15 based on a command from the control unit 19. Consequently, a nugget (spot welded part) 25 is formed between the first aluminum sheet 21 and the second aluminum sheet 23 which are sandwiched by the electrodes 13 and 15, and a resistance spot welded joint (joined body) 27 in which the first aluminum sheet 21 and the second aluminum sheet 23 are integrated is obtained.

In the above example, a resistance spot welded joint 27 of an aluminum material is obtained by joining two aluminum sheets, but the present invention is not limited to joining of two aluminum sheets but is favorably used also in the case of joining three or more aluminum sheets.

In the following description, the direction in which the first aluminum sheet 21 and the second aluminum sheet 23 are stacked is referred to as the sheet thickness direction or the nugget thickness direction (i.e., the depth direction of the penetration depth). As for the nugget, a direction extending radially from the nugget center and being orthogonal to the nugget thickness direction is defined as the nugget radial direction, and the maximum diameter in a direction orthogonal to the nugget thickness direction is defined as the nugget diameter. The nugget thickness direction is the same as the sheet thickness direction of the aluminum sheet and therefore, is appropriately referred also as the sheet thickness direction.

### <Aluminum Material>

As the aluminum material for the first aluminum sheet 21 and the second aluminum sheet 23 and the aluminum material constituting each aluminum sheet in the case of using three or more sheets, an aluminum or aluminum alloy made of any material can be used. Specifically, a 5000 series, 6000 series, 7000 series, 2000 series or 4000 series aluminum alloy and in addition, a 3000 series or 8000 series aluminum alloy as well as 1000 series (pure aluminum) aluminum can be employed. Each aluminum sheet may be made of the same kind of material or may be a combined sheets obtained by combining different kinds of materials.

The sheet thickness of the first aluminum sheet 21 and the second aluminum sheet 23 (in the case of further using other aluminum sheets, including the aluminum sheets) is preferably 0.5 mm or more, more preferably 2.0 mm or more, in structural member applications such as automotive frame member. Each aluminum sheet may have the same sheet thickness, or either one may be thicker than the other. The form of the aluminum material is not limited to the above-described aluminum sheet (rolled sheet) and may be an extruded material, a forged material, or a cast material.

### <Welding Conditions>

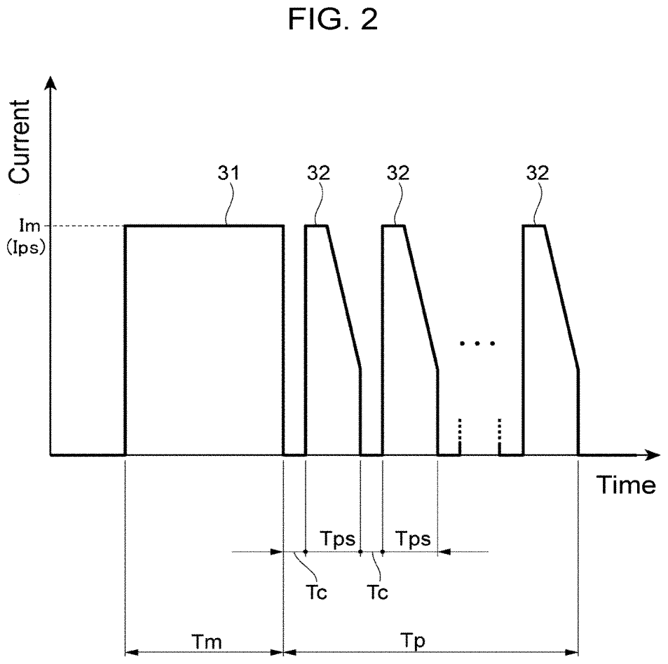

The control unit 19 commands the welding transformer unit 17 to supply a current between the pair of electrodes 13 and 15 at a predetermined timing. FIG. 2 is a timing chart illustrating an example of the waveform of the welding current.

The welding current waveform illustrated in FIG. 2 has a main current supply step (current supply time Tₘ) by the first-stage continuous current supply 31 and a pulsation current supply step (total current supply time Tₚ) of repeatedly supplying a current of a pulse (short pulse) 32 having short current supply time. In the pulsation current supply, stopping of the current supply (cooling time T_{c}) and current supply of pulse 32 (current supply time Tₚₛ) are repeated a plurality of times. The current supply waveform of the first-stage continuous current supply 31 and the second-stage pulse 32 may be rectangular or may be another waveform such as triangular wave or sine wave or a downslope-controlled or upslope-controlled waveform. In the example illustrated in FIG. 2, the continuous current supply 31 is a constant current, and the pulse 32 has a waveform in a rectangular pulse is downslope-controlled. In the case where the current supply waveform is a waveform other than a rectangular waveform, such as downslope or upslope waveform, the maximum current value in each pulse wave is defined as the current value of pulsation current supply.

Both the current value Iₘ of the first-stage continuous current supply 31 and the current value Iₚₛ of the second-stage or subsequent pulse 32 are set within the range of 15 kA to 60 kA. The final nugget size is basically determined by the current value Iₘ of the continuous current supply 31. Therefore, an optimal current value Iₘ should be determined depending on the purpose of welding.

The current value Iₘ of the continuous current supply 31 is preferably from 30 kA to 40 kA, and the current supply time Tₘ is from 100 ms to 300 ms, preferably from 150 ms to 250 ms, more preferably from 180 ms to 220 ms.

The current value during the cooling time Tc of current supply ceasing is 0 A (current supply between electrodes 13 and 15 is stopped) in the example illustrated in FIG. 2 but need not always be 0 A and may be a current higher than 0 A as long as the heat input into the first aluminum sheet 21 and the second aluminum sheet 23 can be reduced to be lower than that during current supply. The cooling time Tc is from 10 to 20 ms, preferably from 10 to 15 ms, more preferably from 10 to 12 ms.

The current value Iₚₛ of the pulse 32 is preferably from 30 kA to 40 kA, and the current supply time Tₚₛ is from 10 ms to 30 ms, preferably 15 ms to 25 ms, more preferably from 18 ms to 22 ms. The number of repetitions of current supply of the pulse 32 (pulse number N) is 3 or more, preferably 4 or more, more preferably 7 or more.

### <Procedure and Effects of Resistance Spot Welding>

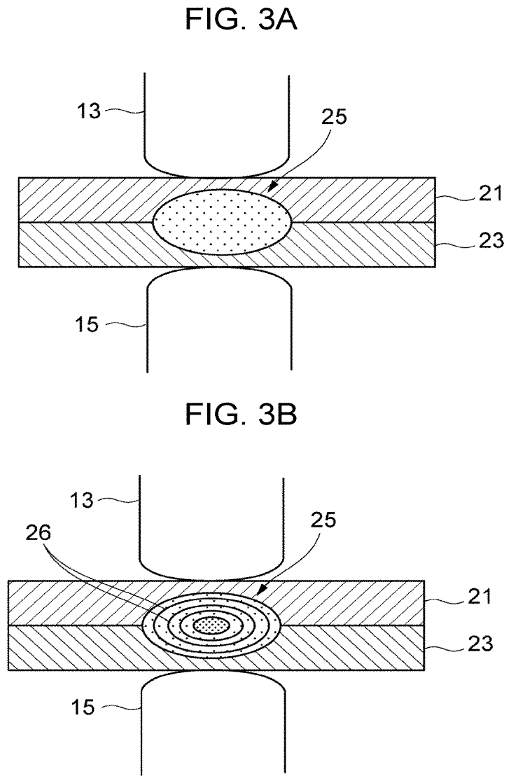

FIG. 3A and FIG. 3B are process explanatory views for schematically illustrating the state of a nugget from the first-stage main current supply to the second-stage pulsation current supply.

As illustrated in FIG. 3A, when a current having a current value Iₘ is supplied in the main current supply to a first aluminum sheet 21 and a second aluminum sheet 23 sandwiched between a pair of electrodes 13 and 15, a nugget 25 is formed mainly in a face where the sheet surfaces contact with each other.

Next, as illustrated in FIG. 3B, as a result of conducting a pulsation current supply by a plurality of short pulses, a plurality of shells 26 having an annular cross-section (hereinafter, referred to as shell) are formed inside the nugget 25. When the nugget 25 is cut in the sheet thickness direction and the cross-section is observed, a striped pattern of shells 26 formed concentrically from the central part of the nugget 25 is observed in the nugget 25.

Formation of the nugget 25 is described in greater detail.

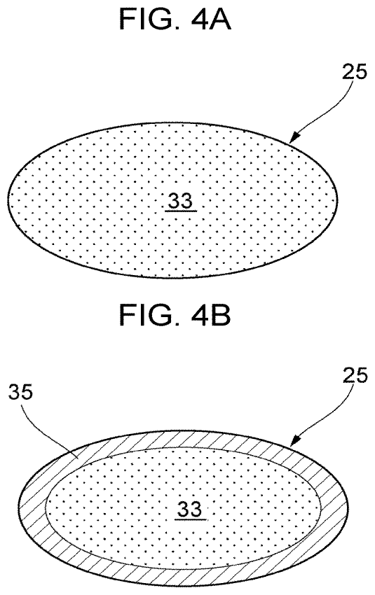

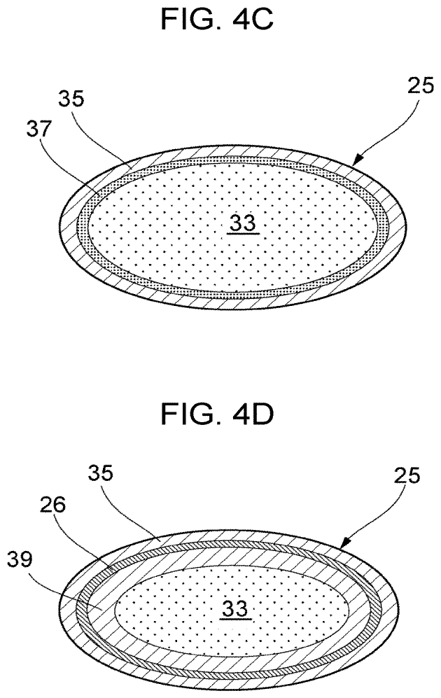

FIG. 4A to FIG. 4D are explanatory views for schematically illustrating the state in the course of forming a nugget 25.

First, in the first-stage main current supply, as illustrated in FIG. 4A, a molten-state nugget (molten nugget 33) 25 is formed. After the formation of the molten nugget 33, the main current supply is stopped, and in turn, the molten nugget 33 starts cooling from the outer circumference. Then, as illustrated in FIG. 4B, a columnar crystal structure develops and solidifies, from the outer periphery of the molten nugget 33 toward the nugget central part, and a solidified part (solidification structure) 35 is thus formed.

Before the columnar crystal structure of the solidified part 35 completely develops in the nugget, pulsation current supply is started. In the pulsation current supply, the above-described first pulsed current supply is performed so as to again melt a portion 37 on the nugget central part side of the solidified part 35 as illustrated in FIG. 4C. This first pulsed current supply is controlled to stop in the state of a portion of the solidified part 35 being melted. The portion 37 in which the above-described columnar crystal structure is melted cools after stopping the first pulsed current supply and again solidifies. Consequently, as illustrated in FIG. 4D, the melted portion 37 solidifies to have a structure different from the columnar crystal structure. This different structure forms the shell 26.

Then, with the progress of cooling of the molten nugget 33, a columnar crystal structure again develops from the inner side of the shell 26 toward the nugget center, and a second-layer solidified part 39 on the shell inner side is thus formed. Subsequently, by performing second pulsed current supply, a portion in which the columnar crystal structure is again melted is formed in the solidified part 39 and serves as a shell, and a third-layer solidified part is thus formed on the inner side of the shell formed.

In this way, pulsed current supply (current supply and cooling) after the main current supply is repeated a plurality of times to form solidified parts 35, 39, . . . having a columnar crystal structure, and a shell 26, such that in a cross-section in the stacking direction of aluminum materials, the solidified part of the aluminum material and a shell 26 having a different solidification structure from the solidified part are alternately formed inside the nugget 25 from the outer edge of the nugget 25 toward the nugget central part. When the nugget 25 after pulsation current supply is observed on a cross-section in the sheet thickness direction, as schematically illustrated in FIG. 3B, a striped pattern in which the shells 26 are concentrically formed as multiple rings is observed. In each of the shell 26 and the solidified part 39, the concentrations of Mg, etc. have different distribution states due to segregation or inverse segregation.

In the nugget 25, a plurality of shells 26 are formed toward the nugget central part by the above-described procedure of resistance spot welding. Because of this, the size of the melted portion (molten nugget 33) surrounded by the shell 26 is reduced in a stepwise manner toward the central part. Accordingly, even when a blowhole is generated in the nugget during the resistance spot welding, the generated blowholes are gathered together in the nugget central part.

Typically, when a blowhole is present in a joint part or in the vicinity of the matrix (in the outer periphery of the nugget) of the aluminum material, the blowhole acts as a starting point, etc. of fracture and therefore, the weld quality is reduced. On the other hand, even when a blowhole is present in the nugget central part, where stress concentration is less likely to occur, a great effect is not exerted on the welded part quality, such as joint strength, etc.

In the present resistance spot welding method, generated blowholes are gathered together in the nugget central part by performing pulsation current supply, and thus a reduction in the welded part quality can be prevented. Consequently, even in the case of aluminum materials such as 5000 series, 6000 series and 7000 series, which contain Mg or Zn that is an element having a low vapor pressure and is likely to cause a formation of a blowhole, a reduction of the welded part quality due to a blowhole can be prevented.

Furthermore, in the nugget formed by the above-described procedure, compared with a nugget formed only by main current supply, the nugget portion is slowly cooled and therefore, nugget cracking is less likely to occur. In order to obtain these effects, the number of shells 26 is preferably 4 or more, more preferably 7 or more.

The current value of a plurality of pulses 32 passing through the electrodes 13 and 15 may be increased every time a current is supplied. In this case, the behavior causing a portion 37, which is a portion on the nugget central part side of the solidified part 35, to again melt is more unfailingly executed, such that the blowhole can be effectively decreased. Furthermore, the solidification rate of the nugget decreases due to an increase in the heating amount and therefore, the nugget is less likely to crack.

As understood from these, in the present resistance spot welding method, even when an aluminum material is welded, the welded part quality (e.g., joint strength) of the welded joint can be enhanced without producing weld defects such as a blowhole.

### <Other Resistance Spot Welding Methods>

In addition, other than conducting main current supply in the first stage and pulsation current supply in the second stage as in the example above, preliminary current supply for preheating may be conducted before main current supply.

In this case, resistance spot welding is performed by conducting a preliminary current supply step of stacking a plurality of aluminum materials one on top of another, sandwiching the stack between a pair of electrodes, and supplying a first current between the electrodes before the main current supply, a cooling step of reducing the heat input into the aluminum material after the preliminary current supply step, and a main current supply step after the cooling step.

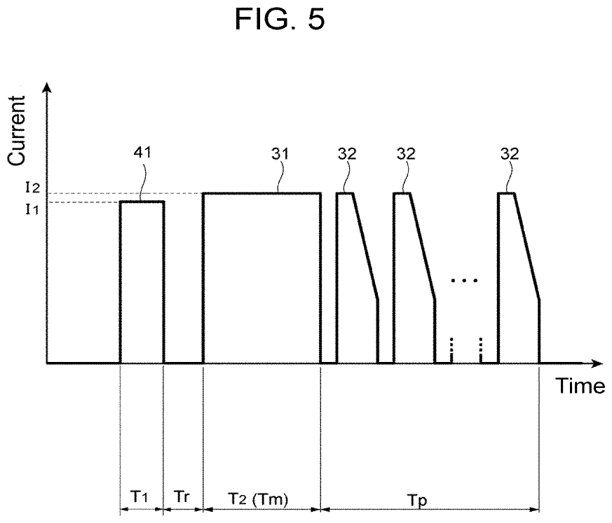

FIG. 5 is a timing chart illustrating an example of the waveform of the welding current in the case of resistance spot welding including a preliminary current supply step, a cooling step, a main current supply step, and a pulsation current supply step.

In this case, preliminary current supply by pulse 41, main current supply by continuous current supply 31, and pulsation current supply by pulse 32 are conducted in the first stage, the second stage, and the third stage, respectively.

When I₁ and T₁ respectively denote the current value and current supply time in the preliminary current supply and I₂ and T₂ respectively denote the current value and current supply time in the main current supply step, the current supply is conducted under the conditions satisfying the relationship of I₁×T₁<I₂×T₂ in the preliminary current supply step and the main current supply step. In addition, the rest time (cooling time) Tᵣ after the preliminary current supply is set to be from 10 ms to 500 ms. By virtue of this, the nugget dimensional ratio D/H of the nugget diameter D to the nugget penetration depth H becomes 2.3 or more. The nugget dimensional ratio is more preferably from 2.3 to 3.4. In the case where the nugget dimensional ratio D/H is within the above range, a joint part where growth of the nugget in the sheet thickness direction is inhibited is formed. On the other hand, if the nugget dimensional ratio D/H is smaller than the above range, the required bonding strength tends to be lacked. In addition, even if the dimensional ratio exceeds the range above, a great increase in the bonding strength cannot be expected.

The current value in the cooling step need not always be 0 A and may be a current higher than 0 A as long as the heat input into the first aluminum sheet 21 and the second aluminum sheet 23 illustrated in FIG. 1 can be reduced to be lower than that during preliminary current supply. The cooling time in the cooling step is from 10 to 500 ms, preferably 100 ms or less, more preferably 60 ms or less.

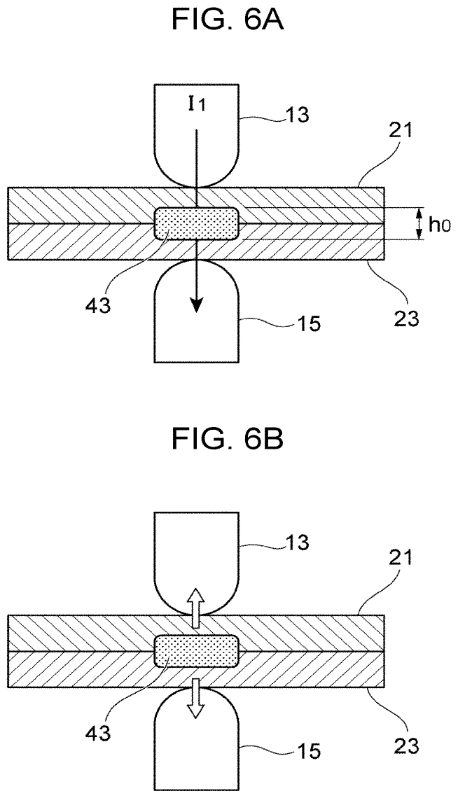

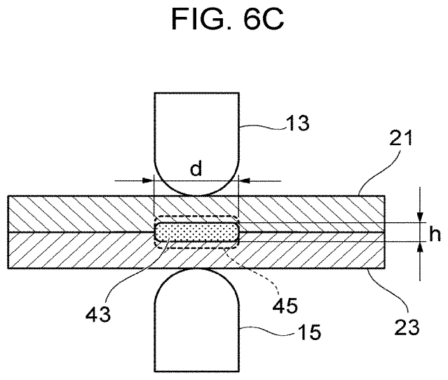

FIG. 6A to FIG. 6C are a process explanatory view for schematically illustrating the state from the preliminary current supply step to the cooling step.

As illustrated in FIG. 6A, a preliminary current of current value I₁ is supplied to the first aluminum sheet 21 and second aluminum sheet 23 sandwiched between a pair of electrodes 13 and 15. At this time, mainly on a face where the first aluminum sheet 21 and the second aluminum sheet 23 are stacked to contact with each other, a first nugget 43 resulting from melting of each of the sheet materials is formed.

In the cooling step after the preliminary current supply, as illustrated in FIG. 6B, current supply between the electrodes 13 and 15 is stopped, and heating between the first aluminum sheet 21 and the second aluminum sheet 23 stops. At this time, the first aluminum sheet 21 and the second aluminum sheet 23 still remain in contact with the electrodes 13 and 15 respectively, and the first nugget 43 in the molten state is deprived of heat by the electrodes 13 and 15. Then, in each of the first aluminum sheet 21 and the second aluminum sheet 23, the temperature near the contact part with the electrode 13 or 15 drops, and solidification of the first nugget 43 proceeds from the side closer to the electrode 13 or 15 as illustrated in FIG. 6C. Consequently, in the first nugget 43, a partially solidified part 45 is gradually formed, and the thickness in the sheet thickness direction (penetration depth) of the molten portion of the first nugget 43 is reduced from the thickness ho FIG. 6A to the thickness h.

Next, after the completion of the above-described cooling step, the main current supply step is started.

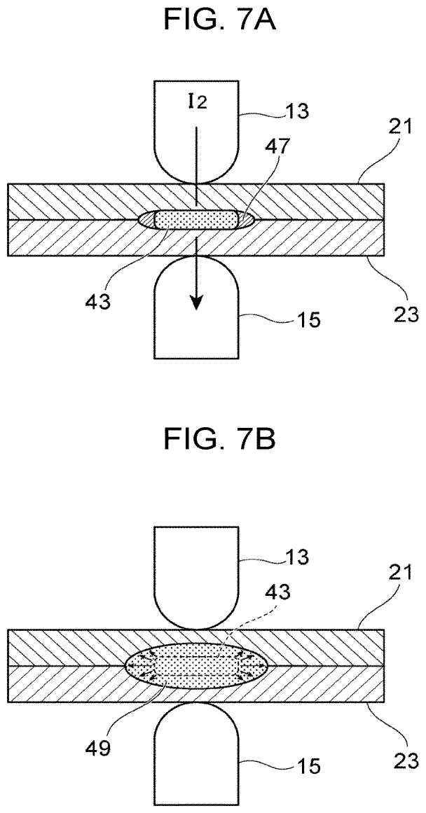

FIG. 7A to FIG. 7B are process explanatory views for schematically illustrating how the main current supply step is performed after the cooling step.

In the main current supply step, as illustrated in FIG. 7A, a current 12 is supplied between the electrodes 13 and 15. When the current 12 passes through the first aluminum sheet 21 and the second aluminum sheet 23, the resistance of the region 47 on the nugget diameter-direction outer side of the first nugget 43 is larger than that of the inside of the first nugget 43 being in the molten state.

The electrical resistance in the high-temperature first nugget 43 heated by current supply increases to be greater than in the member around the nugget, but the electrical resistance in the region 47 is further greater. Accordingly, in the main current supply step, the region 47 serves as a large heat source, and the region 47 on the outer side in the nugget diameter direction is more heated than the outer edge of the first nugget 43. Accordingly, as illustrated in FIG. 7B, the growth of the first nugget 43 is promoted more preferentially in the nugget diameter direction than in the sheet thickness direction.

In this way, the region 47 on the nugget diameter-direction outer side with respect to the outer peripheral edge of the first nugget 43 is preferentially heated by the current 12 of main current supply. Because of this, the first nugget 43 grows radially outward particularly from the outer peripheral edge of the first nugget 43, and the growth in the sheet thickness direction is inhibited, compared with the nugget diameter direction. As a result, after the main current supply, a flat-shaped second nugget 49 is formed.

In addition, even if a first nugget 43 is not formed by the preliminary current supply, when the preliminary current supply is performed under predetermined conditions, a nugget 25 in which the above-described growth in the sheet thickness direction is inhibited is obtained. The reason therefor is considered as follows.

A face where respective sheet surfaces of a plurality of stacked aluminum sheets are stacked to contact with each other is covered with an insulating layer such as an oxide film. Then, when preliminary current supply is conducted before main current supply, the insulating layer on the aluminum sheet surface is broken, and a large number of new surfaces are formed in a certain region on the sheet surface.

When main current supply is conducted in this state, heat generation is promoted in a portion having a high electrical resistance including a slight gap (space or an insulating layer remaining without being broken) formed around the new surface region, and therefore, growth in the nugget diameter direction from the new surface region is promoted. On the other hand, as for the growth of nugget in the sheet thickness direction, since a first nugget has not been formed at the start of main current supply, the growth in the nugget diameter direction becomes large, compared with the growth in the sheet thickness direction.

In both cases, during resistance spot welding of a plurality of aluminum sheets, the nugget formed by melting of the aluminum sheet is formed in a flat shape without making the thickness in the sheet thickness direction of the aluminum sheet excessive. Therefore, the nugget does not reach the sheet surface on the sheet thickness-direction outer side (outer surface on the electrode side). As a result, molten aluminum does not attach to the electrode surface, and the frequency of dressing of the electrode surface can be reduced, such that the number of continuous spots until the next dressing can be increased. In addition, keeping the nugget thickness small while increasing the nugget diameter can be easily realized without performing a complicated control of the pressure force of an electrode and welding current. Consequently, a high welded part quality can be ensured without producing a weld defect in the aluminum welded part formed by resistance spot welding.

### EXAMPLES

Examples of the production method of the resistance spot welded joint of an aluminum material in the present invention is described below.

Here, the results of resistance spot welding using stacked two or three aluminum sheets which were made of the same material and have the same dimension are described. The conditions of each of the first-stage current supply and the second-stage current supply were changed.

### <Test Conditions>

### (Aluminum Sheet)

Specimen 1
Material: A5182 material (Al—Mg aluminum alloy)
Sheet thickness: 2.3 mm

Specimen 2
Material: A6022 material (Al—Mg—Si aluminum alloy)
Sheet thickness: 2.0 mm

### (Electrode)

Type: chromium copper, R-type electrode
Tip radius of curvature: 100 mm
Electrode diameter (base diameter): 19 mm

### (Welding Conditions)

1) Pressure force between electrodes: 5 kN
2) Welding current (see Tables 1 to 4)

Main current supply
Current value Iₘ: 31 kA to 33 kA
Current supply time Tₘ: 167 ms to 200 ms
Current waveform: rectangular wave or downslope-controlled rectangular wave

Pulsation current supply
Initial current value Iₚₛ₁: 31 kA to 38 kA
Final current value Iₚₛ₂: 35 kA to 40.8 kA
Total current supply time Tₚ: 128 ms to 224 ms
Current supply time Tₚₛ of single pulse: 20 ms
Cooling time T_{c}: 12 ms
Pulse number N: 4 to 7
Pulse waveform: downslope-controlled rectangular wave

### <Test Results>

### (First Test)

While applying a pressure to a stack of two sheets of Specimen 1 held between a pair of electrodes, first-stage main current supply was conducted under a certain condition by continuous current supply (without downslope control) with a current value Iₘ of 31 kA and a current supply time Tₘ of 200 ms. Furthermore, second-stage pulsation current supply was conducted by changing the conditions. The results are shown in Table 1.

TABLE 1

| | | | | | Second Stage (pulsation current supply) | | | | | | |
|---|---|---|---|---|---|---|---|---|---|---|---|
| | | First Stage (main current supply) | | | | | | Total | | | |
| | | | Current | | Pulse | Initial | Final | Current | Results | | |
| | | Current | supply | | Number | Current | Current | supply | Nugget | | |
| | | Value Iₘ | Time Tₘ | Waveform | N | Value Iₚₛ₁ | Value Iₚₛ₂ | Time Tₚ | Diameter | State of | |
| | Specimen | [kA] | [ms] | DS | [times] | [kA] | [kA] | [ms] | [mm] | Nugget | Rating |
| Test Example A1 | Specimen 1 | 31 | 200 | none | 7 | 32.4 | 40.8 | 224 | 8.52 | fine | A |
| | | | | | | | | | | blowhole | |
| Test Example A2 | Specimen 1 | 31 | 200 | none | 7 | 31 | 37 | 224 | 7.83 | good | AA |

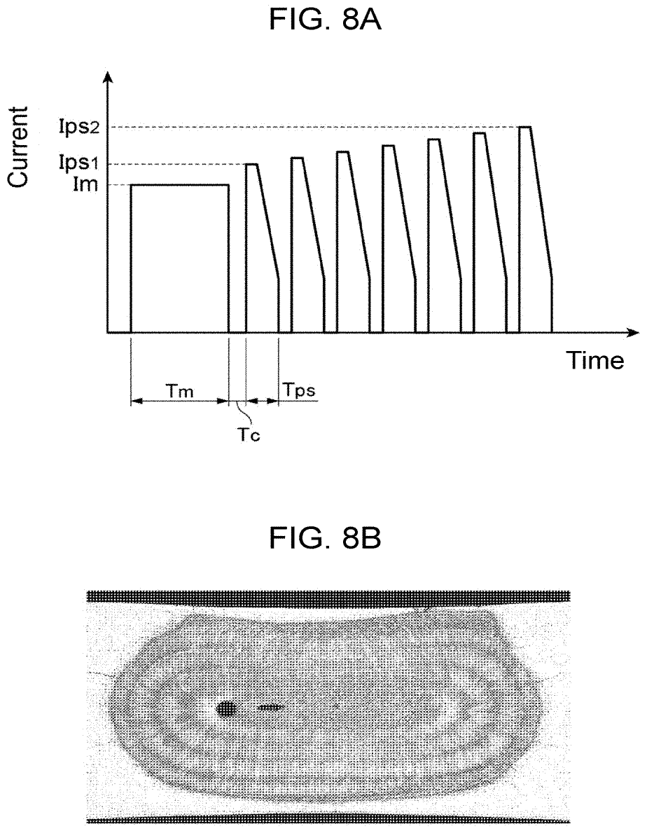

As illustrated in FIG. 8A, pulsation current supply with a pulse number N of 7, in which the current value was gradually increased every time each current pulse was supplied, was performed.

In Test Example A1, the initial current value Iₚₛ₁ was 32.4 kA, and the final current value Iₚₛ₂ was 40.8 kA. In Test Example A2, the initial current value Iₚₛ₁ was 31 kA, and the final current value Iₚₛ₂ was 37 kA.

The evaluation results are shown in Table 1, and a cross-sectional photograph of the nugget of Test Example A1 is illustrated in FIG. 8B.

The evaluation criteria for State of Nugget in the column of Results in the Table are as follows.

Blowhole: The maximum blowhole diameter is 1 mm or more.

Fine blowhole: the maximum blowhole diameter is 100 μm or more and less than 1 mm.

Good: The maximum blowhole diameter is less than 100 μm (including the case where a blowhole is not observed).

The column of Evaluation is as follows.

AA: Very good (No cracking, and almost no blowhole is present.)

A: Good (No cracking, but a small number of blowholes are present.)

C: Bad (Cracking is observed, or large blowholes are present.)

The evaluation criteria are the same in Tables 2 to 4.

The nuggets of Test Examples were nuggets of good size having a nugget diameter of 8.52 mm and 7.83 mm (in terms of the measured value by a cross-sectional macroscopic view: in the following Test Examples, measured in the same manner), respectively.

In both of Test Examples A1 and A2, a clear striped pattern was formed in a cross-section of the nugget, and particularly in the nugget of Test Example A2, a blowhole was substantially not observed, indicating that the nugget was in a good state.

### (Second Test)

While applying a pressure to a stack of two sheets of Specimen 1 held between a pair of electrodes, first-stage main current supply was conducted under certain conditions by continuous current supply (without downslope control) with a current value Iₘ of 33 kA and a current supply time Tₘ of 167 ms. Furthermore, second-stage pulsation current supply was conducted in some Test Examples and was not conducted in the other Test Example. With respect to Test Examples where pulsation current supply was conducted, pulsation current supply was conducted at a constant current value over the entire period of current supply. The results are shown in Table 2.

TABLE 2

| | | | | | Second Stage (pulsation current supply) | | | | | |
|---|---|---|---|---|---|---|---|---|---|---|
| | | First Stage (main current supply) | | | | | Total | | | |
| | | | Current | | Pulse | | Current | Results | | |
| | | Current | supply | | Number | Current | supply | Nugget | | |
| | | Value Iₘ | Time Tₘ | Waveform | N | Value Iₚₛ | Time Tₚ | Diameter | State of | |
| | Specimen | [kA] | [ms] | DS | [times] | [kA] | [ms] | [mm] | Nugget | Rating |
| Test Example B1 | Specimen 1 | 33 | 167 | none | — | — | — | 7.28 | cracking, | C |
| | | | | | | | | | fine | |
| | | | | | | | | | blowhole | |
| Test Example B2 | Specimen 1 | 33 | 167 | none | 7 | 38 | 224 | 7.95 | good | AA |
| Test Example B3 | Specimen 1 | 31 | 200 | none | 4 | 31 | 128 | 7.95 | fine | A |
| | | | | | | | | | blowhole | |
| Test Example B4 | Specimen 1 | 31 | 200 | present | 4 | 31 | 128 | 8.46 | fine | A |
| | | | | | | | | | blowhole | |
| Test Example B5 | Specimen 1 | 31 | 200 | none | 7 | 31 | 224 | 8.15 | fine | A |
| | | | | | | | | | blowhole | |
| Test Example B6 | Specimen 1 | 31 | 200 | present | 7 | 31 | 224 | 8.31 | fine | A |
| | | | | | | | | | blowhole | |

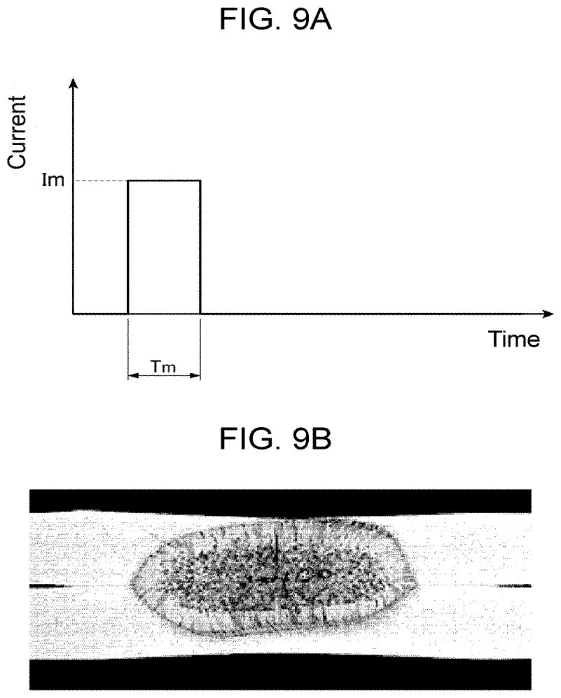

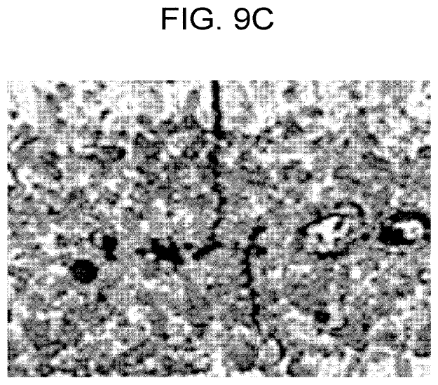

In Test Example B1, as illustrated in FIG. 9A, only the first-stage main current supply was conducted, and pulsation current supply was not conducted. FIG. 9B illustrates a cross-sectional photograph of the nugget of Test Example B1. FIG. 9C is an enlarged photograph of the nugget central part depicted in FIG. 9B.

As illustrated in FIG. 9C, in the nugget of Test Example B1, cracking and blowholes were observed in the nugget central part.

In Test Example B2, after the same first-stage current supply as in Test Example B1, pulsation current supply with a pulse number N of 7 was performed with a constant current value Iₚₛ increased to as high as 38 kA. In the nugget of Test Example B3, cracking or a blowhole was substantially not observed, and the size of the nugget was good.

In this way, by conducting pulsation current supply, generation of blowholes or cracking was resolved.

In Test Examples B3 to B6, while applying a pressure to a stack of two sheets of Specimen 1 held between a pair of electrodes, continuous current supply with a current value Iₘ of 31 kA and a current supply time Tₘ of 200 ms was conducted as the first-stage current supply, and the second-stage pulsation current supply was conducted by changing the conditions. The pulsation current supply was conducted at a constant current value over the entire period of current supply.

In Test Example B3, after the first-stage current supply by continuous current supply (without downslope control), pulsation current supply with a pulse number N of 4 was conducted by setting the current value Iₚₛ to a constant value of 31 kA. In the nugget of Test Example D1, only fine blowholes were observed, and the nugget diameter was 7.95 mm.

In Test Example B4, the current was supplied under the same conditions as in Test Example B3 except for the downslope control of the first-stage continuous current supply.

In the nugget of Test Example B4, only fine blowholes were observed, and the nugget diameter was 8.46 mm, showing an increase in the nugget diameter from Test Example B3.

In Test Example B5, after the first-stage current supply by continuous current supply (without downslope control), pulsation current supply with a pulse number N of 7 was conducted by setting the current value Iₚₛ to a constant value of 31 kA. In the nugget of Test Example B5, only fine blowholes were observed, and the nugget diameter was 8.15 mm.

In Test Example B6, the current was supplied under the same conditions as in Test Example B5 except for the downslope control of the first-stage continuous current supply. In the nugget of Test Example B6, only fine blowholes were observed, and the nugget diameter was 8.31 mm, showing an increase in the nugget diameter from Test Example B5.

### (Third Test)

While applying a pressure to a stack of two sheets of Specimen 1 held between a pair of electrodes, pulsation current supply was conducted in the first stage, and main current supply by continuous current supply was conducted in the second stage. The results are shown in Table 3.

TABLE 3

| | | First Stage (pulsation current supply) | | | | | | | | |
|---|---|---|---|---|---|---|---|---|---|---|
| | | | | Total | Second Stage (main current supply) | | | | | |
| | | Pulse | | Current | | Current | | Results | | |
| | | Number | Current | supply | Current | supply | | Nugget | | |
| | | N | Value Iₚₛ | Time Tₚ | Value Iₘ | Time Tₘ | Waveform | Diameter | State of | |
| | Specimen | [times] | [kA] | [ms] | [kA] | [ms] | DS | [mm] | Nugget | Rating |
| Test Example C1 | Specimen 1 | 4 | 31 | 128 | 31 | 200 | none | 7.26 | blowhole | C |
| Test Example C2 | Specimen 1 | 4 | 31 | 128 | 31 | 200 | present | 7.45 | blowhole | C |
| Test Example C3 | Specimen 1 | 7 | 31 | 224 | 31 | 200 | none | 6.44 | fine | C |
| | | | | | | | | | blowhole | |
| Test Example C4 | Specimen 1 | 7 | 31 | 224 | 31 | 200 | present | 6.96 | blowhole | C |

In Test Example C1, pulsation current supply with a pulse number N of 4 was conducted by setting the current value Iₚₛ to a constant value of 31 kA in the first stage, and main current supply by continuous current supply (without downslope control) with a current value Iₘ of 31 kA and a current supply time Tₘ of 200 ms was conducted in the second stage. In the nugget of Test Example C1, blowholes having a diameter of 1 mm or more were observed, and the nugget diameter was 7.26 mm.

In Test Example C2, the current was supplied under the same conditions as in Test Example C1 except for performing downslope control of the continuous current supply of the second-stage main current supply. The nugget diameter was 7.45 mm and was substantially not changed from the nugget diameter of Text Example C1. In addition, blowholes were almost the same as those of Test Example C1.

In Test Example C3, pulsation current supply with a pulse number N of 7 was conducted by setting the current value Iₚₛ to a constant value of 31 kA in the first stage. In addition, main current supply by continuous current supply (without downslope control) with a current value Iₘ of 31 kA and a current supply time Tₘ of 200 ms was conducted in the second stage. In the nugget of Text Example C3, the nugget diameter was 6.44 mm and was small compared with the nugget diameters of Test Examples C1 and C2. As for the blowhole, the blowhole diameter was smallest among Text Examples C1 to C4.

In Test Example C4, the current was supplied under the same conditions as in Test Example C3 except for performing downslope control of the continuous current supply of the second-stage main current supply. In the nugget of Test Example C4, blowholes of the same size as those of Test Examples C1 and C2 were observed. In addition, the nugget size was 6.96 mm and was small compared with those of Test Examples C1 and C2.

These results show that when pulsation current supply is conducted in the first stage, blowholes were generated in all cases and compared with Test Examples A1, A2 and B1 to B6 where pulsation current supply is conducted in the second stage, the nugget diameter was reduced.

### (Fourth Test)

While applying a pressure to a stack of three sheets of Specimen 2 held between a pair of electrodes, first-stage main current supply was conducted under given conditions by continuous current supply with a current value Iₘ of 32 kA and a current supply time Tₘ of 167 ms. Furthermore, second-stage pulsation current supply was conducted or not conducted, and when conducted, the conditions thereof were changed. The results are shown in Table 4.

TABLE 4

| | | | | | Second Stage (pulsation current supply) | | | | | | |
|---|---|---|---|---|---|---|---|---|---|---|---|
| | | First Stage (main current supply) | | | | | | Total | | | |
| | | | Current | | Pulse | Initial | Final | Current | Results | | |
| | | Current | supply | | Number | Current | Current | supply | Nugget | | |
| | | Value Iₘ | Time Tₘ | Waveform | N | Value Iₚₛ₁ | Value Iₚₛ₂ | Time Tₚ | Diameter | State of | |
| | Specimen | [kA] | [ms] | DS | [times] | [kA] | [kA] | [ms] | [mm] | Nugget | Rating |
| Test Example D1 | Specimen 2 | 32 | 167 | none | — | — | — | — | 7.76 | cracking, | C |
| | | | | | | | | | | fine | |
| | | | | | | | | | | blowholes | |
| Test Example D2 | Specimen 2 | 32 | 167 | none | 7 | 32 | 35 | 154 | 7.65 | fine | A |
| | | | | | | | | | | blowholes | |
| Test Example D3 | Specimen 2 | 32 | 167 | none | 7 | 33 | 36 | 154 | 7.83 | good | AA |

In Test Example D1, only first-stage main current supply was conducted, and pulsation current supply was not conducted. In the nugget of Test Example D1, cracking was observed in the nugget central part. In addition, many fine blowholes were formed within the nugget.

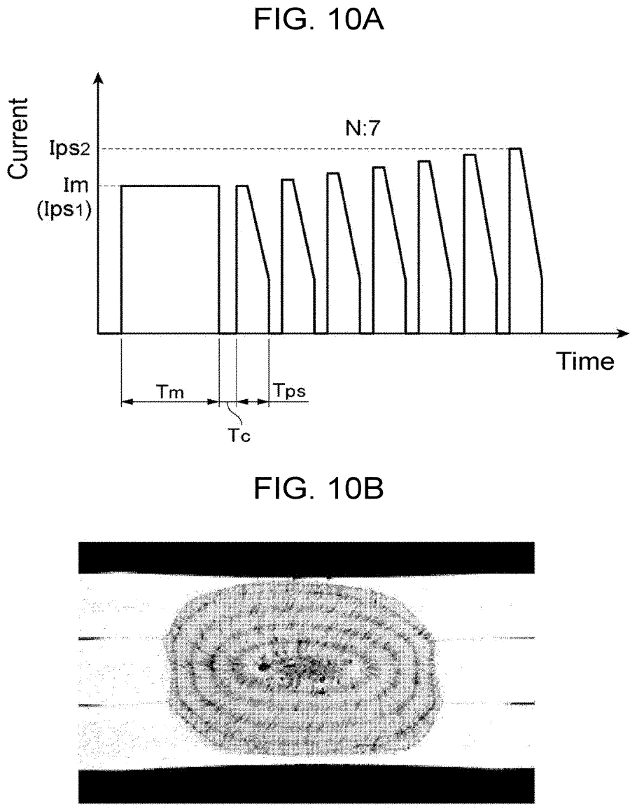

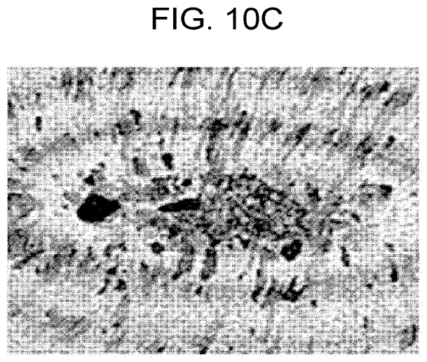

In Test Example D2, as illustrated in FIG. 10A, after first-stage main current supply, pulsation current supply was performed by setting the initial current value Iₚₛ₁ to 32 kA and the final current value Iₚₛ₂ to 35 kA and increasing the current value every time a short pulsed (pulse number N is 7) current was supplied. FIG. 10B illustrates a cross-sectional photograph of the nugget of Test Example D2, and FIG. 10C is an enlarged photograph of the nugget central part. In the nugget of Test Example D2, only fine blowholes were observed, compared with Test Example D1.

In Test Example D3, after the first-stage main current supply, pulsation current supply was conducted by setting the initial current value Iₚₛ₁ to 33 kA and a final current value Iₚₛ₂ to 36 kA and increasing the current value every time a short pulsed (pulse number N is 7) current was supplied. In the nugget of Test Example D3, almost no blowholes were observed.

The nugget diameter was 7.76 mm in Test Example D1, 7.65 mm in Test Example D2, and 7.83 mm in Test Example D3. All of individual nuggets grew to a size sufficient to provide adequate bonding strength.

The present invention is not limited to the embodiments above, and combinations of respective configurations of the embodiments above and changes or applications made by a person skilled in the art based on the description of the present specification as well as common techniques are also intended to be encompassed by the present invention and included within the scope of sought protection.

As described above, the following matters are disclosed in the present description.

(1) A resistance spot welded joint of an aluminum material, obtained by joining a stack of a plurality of aluminum materials by spot welding, in which:

a nugget formed by the spot welding includes a solidified part of the aluminum materials and a shell having a different solidification structure from the solidified part;

the shell is formed annularly in a cross-section of the nugget in a stacking direction of the aluminum materials; and

the solidified part and the shell are alternately arranged from an outer edge of the nugget toward a nugget central part.

In this resistance spot welded joint of an aluminum material, since a plurality of shells are formed toward the nugget central part, the melted portion surrounded by a shell is reduced in size in a stepwise manner toward the central part. Accordingly, even in the case where a blowhole is generated within the nugget during the resistance spot welding, the blowholes are gathered together in the nugget central part, such that reduction in the welded part quality can be prevented. Consequently, there is no degradation of the weld quality, such as blowhole.

(2) The resistance spot welded joint of an aluminum material according to (1), in which the number of the shell formed inside the nugget is four or more.

In this resistance spot welded joint of an aluminum material, the nugget is slowly cooled and therefore, cracking of the nugget is less likely to occur.

(3) The resistance spot welded joint of an aluminum material according to (2), in which the number of the shell formed inside the nugget is seven or more.

In this resistance spot welded joint of an aluminum material, cracking of the nugget can be made to be even less likely to occur.

(4) The resistance spot welded joint of an aluminum material according to any one of (1) to (3), in which the nugget is formed inside an outer surface of the aluminum materials in the stacking direction.

In this resistance spot welded joint of an aluminum material, molten aluminum does not adhere to the electrode surface, and the electrode tip shape can be prevented from changing by a small number of spots. Consequently, the frequency of dressing can be reduced, and the number of continuous spots until the next dressing can be increased.

(5) The resistance spot welded joint of an aluminum material according to any one of (1) to (4), in which the aluminum material is a 5000 series, 6000 series, or 7000 series aluminum alloy.

In this resistance spot welded joint of an aluminum material, even in the case of an aluminum material containing an Mg or Zn element having a low vapor pressure such that defects such as cracking or a blowhole are likely to occur, the cracking of the nugget or generation of a blowhole can be reduced.

(6) A resistance spot welding method of an aluminum material, including conducting, in the following order:

a first step of stacking a plurality of aluminum materials and sandwiching the stack between electrodes for spot welding;

a second step of performing a main current supply for forming a nugget between the aluminum materials sandwiched between the electrodes; and

a third step of performing, before the nugget is completely solidified, a pulsation current supply in which supplying a current between the electrodes and stopping supplying the current between the electrodes are repeated a plurality of times, thereby forming a solidified part of the aluminum materials and a shell having a different solidification structure from the solidified part inside the nugget, the solidified part and the shell being alternately formed from an outer edge of the nugget toward a nugget central part in a cross-section in a stacking direction of the aluminum materials.

In this resistance spot welding method of an aluminum material, since a plurality of shells are formed toward the nugget central part, the melted portions surrounded by a shell become small in size in a stepwise manner toward the central part. Accordingly, even in the case where a blowhole is generated within the nugget in the resistance spot welding, the blowholes are gathered together in the nugget central part, such that the reduction in the welded part quality can be prevented. Consequently, there is no degradation of the weld quality, such as a blowhole.

(7) The resistance spot welding method of an aluminum material according to (6), in which current values in the main current supply and the pulsation current supply are from 15 kA to 60 kA.

In this resistance spot welding method of an aluminum material, the current density in the current supply channel is increased, and heat generation from between aluminum materials is encouraged, such that the welding can be conducted efficiently.

(8) The resistance spot welding method of an aluminum material according to (6) or (7), in which a current value in the pulsation current supply is higher than a current value in the main current supply.

In this resistance spot welding method of an aluminum material, generation of a blowhole can be prevented.

(9) The resistance spot welding method of an aluminum material according to any one of (6) to (8), in which in the pulsation current supply, supplying the current and stopping supplying the current are repeated at least four times.

In this resistance spot welding method of an aluminum material, blowholes generated inside the nugget in the molten state can be gathered together in the nugget central part where the stress concentration is less likely to occur, and further, the blowhole can be reduced in size.

(10) The resistance spot welding method of an aluminum material according to (9), in which in the pulsation current supply, supplying the current and stopping supplying the current are repeated at least seven times.

In this resistance spot welding method of an aluminum material, blowholes inside the nugget in the molten state can be more unfailingly gathered together near the nugget central part.

(11) The resistance spot welding method of an aluminum material according to any one of (6) to (10), in which in the pulsation current supply, current values of a plurality of current pulses supplied between the electrodes are increased every time a current is supplied.

In this resistance spot welding method of an aluminum material, cracking of the nugget is less likely to occur.

(12) The resistance spot welding method of an aluminum material according to any one of (6) to (11), in which the nugget is formed inside an electrode-side surface of the aluminum materials and an outer surface of the aluminum materials in the stacking direction.

In this resistance spot welding method of an aluminum material, molten aluminum does not adhere to the electrode surface, and the electrode tip shape can be prevented from changing by a small number of spots. Consequently, the frequency of dressing can be reduced, and the number of continuous spots until the next dressing can be increased.

This application is based on Japanese Patent Application No. 2018-81781 filed on Apr. 20, 2018, the contents of which are incorporated in the present application by way of reference.

### REFERENCE SIGNS LIST

13, 15 Electrode
21 First aluminum sheet (aluminum material)
23 Second aluminum sheet (aluminum material)
25 Nugget
26 Shell
27 Resistance spot welded joint of aluminum material

1. A resistance spot welded joint of an aluminum material, obtained by joining a stack of a plurality of aluminum materials by spot welding, wherein:
a nugget formed by the spot welding comprises a solidified part of the aluminum materials and a shell having a different solidification structure from the solidified part;
the shell is formed annularly in a cross-section of the nugget in a stacking direction of the aluminum materials; and
the solidified part and the shell are alternately arranged from an outer edge of the nugget toward a nugget central part.

2. The resistance spot welded joint of an aluminum material according to claim 1, wherein the number of the shell formed inside the nugget is four or more.

3. The resistance spot welded joint of an aluminum material according to claim 2, wherein the number of the shell formed inside the nugget is seven or more.

4. The resistance spot welded joint of an aluminum material according to claim 1, wherein the nugget is formed inside an outer surface of the aluminum materials in the stacking direction.

5. The resistance spot welded joint of an aluminum material according to claim 1, wherein the aluminum material is a 5000 series, 6000 series, or 7000 series aluminum alloy.

6. A method for resistance spot welding of an aluminum material, the method comprising, in the following order:
stacking a plurality of aluminum materials and sandwiching a stack formed thereby between electrodes for spot welding;
performing a main current supply for forming a nugget between the aluminum materials sandwiched between the electrodes; and
performing, before the nugget is completely solidified, a pulsation current supply in which supplying a current between the electrodes and stopping supplying the current between the electrodes are repeated a plurality of times, thereby forming a solidified part of the aluminum materials and a shell having a different solidification structure from the solidified part inside the nugget, the solidified part and the shell being alternately formed from an outer edge of the nugget toward a nugget central part in a cross-section in a stacking direction of the aluminum materials.

7. The method according to claim 6, wherein current values in the main current supply and the pulsation current supply are from 15 kA to 60 kA.

8. The method according to claim 6, wherein a current value in the pulsation current supply is higher than a current value in the main current supply.

9. The method according to claim 6, wherein in the pulsation current supply, supplying the current and stopping supplying the current are repeated at least four times.

10. The method according to claim 9, wherein in the pulsation current supply, supplying the current and stopping supplying the current are repeated at least seven times.

11. The method according to claim 6, wherein in the pulsation current supply, current values of a plurality of current pulses supplied between the electrodes are increased every time a current is supplied.

12. The method according to claim 6, wherein the nugget is formed inside an electrode-side surface of the aluminum materials and an outer surface of the aluminum materials in the stacking direction.
